(19) United States
(12) Patent Application Publication
(10) Pub. No.: US 2008/0281940 A1
(43) Pub. Date: Nov. 13, 2008

(54) ADVERTISING ON A PORTABLE COMMUNICATION DEVICE

(75) Inventor: Robert Andrew Coxhill, Bolton (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/751,212

(22) Filed: May 21, 2007

Related U.S. Application Data
(60) Provisional application No. 60/917,537, filed on May 11, 2007.

(51) Int. Cl. G06F 15/16

(52) U.S. Cl. 709/217

(57) ABSTRACT

A device and method of displaying advertisements on an electronic device. The method includes providing an advertisement to the electronic device, detecting at least one prescribed condition of the electronic device corresponding to display of the advertisement, and displaying the advertisement on a display of the electronic device when the prescribed condition is detected. The advertisement is displayed for a prescribed period of time during which the advertisement can be canceled based on the occurrence of a predefined event. Advertisements can be targeted to the user of the phone based on one or more user preferences.

### TECHNICAL FIELD OF THE INVENTION

The present invention relates generally to portable communication devices, and, more particularly, to a method for displaying advertisements on a portable communication device.

### DESCRIPTION OF THE RELATED ART

Traditionally, commercial advertisements have been in the form of television commercials, radio commercials, and printed advertisements in magazines, newspapers, etc. More recently, as people began spending more and more time using personal computers, advertising has expanded to the internet. Internet advertisements are often found in the form of pop-up advertisements that automatically launch a new browser window containing the advertisement. A user typically must close the advertisement to remove it from the screen. Such advertisements can aggravate users causing them to seek out methods to block the advertisements, such as popup blocker programs.

As mobile and/or wireless electronic devices become increasingly popular, delivering advertisements to users of such devices is likely to become increasingly popular. Such devices include, for example, mobile telephones, portable media players and portable gaming devices. Many of these devices include features such as cameras, text messaging capability, Internet browsing capability, electronic mail capability, video playback capability, audio playback capability, image display capability and handsfree headset interfaces. Accordingly, such devices are typically capable of displaying audiovisual and/or text advertisements.

### SUMMARY

To improve advertising on portable communication devices, there is a need in the art for a system and method for displaying advertisements on an electronic device when the device is in a prescribed state, for example, when a keyguard is activated. Advertisements can be downloaded, streamed, or otherwise provided to the device and displayed periodically. The advertisements can be displayed for a prescribed period of time during which the user typically cancels the advertisement to access the normal features of the device. The advertisement can be automatically canceled in some instances. Advertisements can be targeted to the user of the device based on one or more user preferences.

According to one aspect of the invention, there is provided a method of displaying advertisements on an electronic device comprising providing an advertisement to the electronic device, detecting at least one prescribed condition of the electronic device corresponding to display of the advertisement, and displaying the advertisement on a display of the electronic device when the prescribed condition is detected. The advertisement is displayed for a prescribed period of time during which the advertisement can be canceled based on the occurrence of a predefined event.

According to another aspect of the invention, the predefined event includes cancellation of the advertisement by a user.

According to another aspect of the invention, providing an advertisement to the electronic device includes streaming the advertisement to the device.

According to another aspect of the invention, providing an advertisement to the electronic device includes downloading the advertisement to a memory of the device.

According to another aspect of the invention, the prescribed condition is a period of inactivity of the electronic device.

According to another aspect of the invention, the prescribed condition is a geographical location of the electronic device.

According to another aspect of the invention, the advertisement is at least one of an image, a video, a sound, or text.

According to another aspect of the invention, the advertisement includes a link selectively activatable by the user for accessing additional information.

According to another aspect of the invention, the advertisement is downloaded to the memory of the electronic device via a communications network.

According to another aspect of the invention, the method further comprises activating at least one of an audio and a visual indicator for alerting the user to the display of the advertisement.

According to another aspect of the invention, the method further comprises targeting advertisements based upon information available from the electronic device, wherein the targeting includes accessing a memory of the electronic device, the memory including data related to the operation of the electronic device, analyzing at least the data related to operation of the electronic device to determine at least one user preference, generating a list of user preferences, and using the list of preferences to determine advertisements provided to the electronic device for display to the user.

According to another aspect of the invention, the method further comprises searching an advertisement server for advertisements related to the determined preferences.

According to another aspect of the invention, the accessing the memory includes accessing at least one of call log data, message log data, video/picture log data, MP3 log data, location log data, environmental log data, calendar log data, user defined preference log data, and voice memo log data.

According to another aspect of the invention, the advertisement is a limited time advertisement that expires after a prescribed time.

According to another aspect of the invention, the advertisement is automatically canceled upon the occurrence of a predefined event.

According to another aspect of the invention, a method of targeting advertisements based upon information available from an electronic device comprises accessing a memory of the electronic device, the memory including data related to the operation of the electronic device, analyzing at least the data related to operation of the electronic device to determine at least one user preference, generating a list of user preferences, and using the list of preferences to determine advertisements to be provided to the electronic device for display to the user.

According to another aspect of the invention, the method further comprises searching an advertisement server for advertisements related to the determined preferences.

According to another aspect of the invention, the accessing the memory includes accessing at least one of call log data, message log data, video/picture log data, MP3 log data, location log data, environmental log data, calendar log data, user defined preference log data, and voice memo log data.

According to another aspect of the invention, an electronic device comprises call circuitry to establish a communication link to a communication network, and advertising circuitry. The advertising circuitry is operative to retrieve an advertisement, detect at least one prescribed condition of the electronic device corresponding to display of the advertisement, and display the advertisement on a display of the electronic device when the prescribed condition is detected. The advertisement is displayed for a prescribed period of time during which the advertisement can be canceled based on the occurrence of a predefined event.

According to another aspect of the invention, the electronic device is a mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate;

FIG. 4 is a flow chart representing an exemplary method of displaying advertisements using the mobile telephone of FIG. 1.

FIG. 5 is a flow chart representing an exemplary method of selecting advertisements based on user information stored in a memory of an electronic device.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic device” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic device, examples of which include a media player, a gaming device, etc.

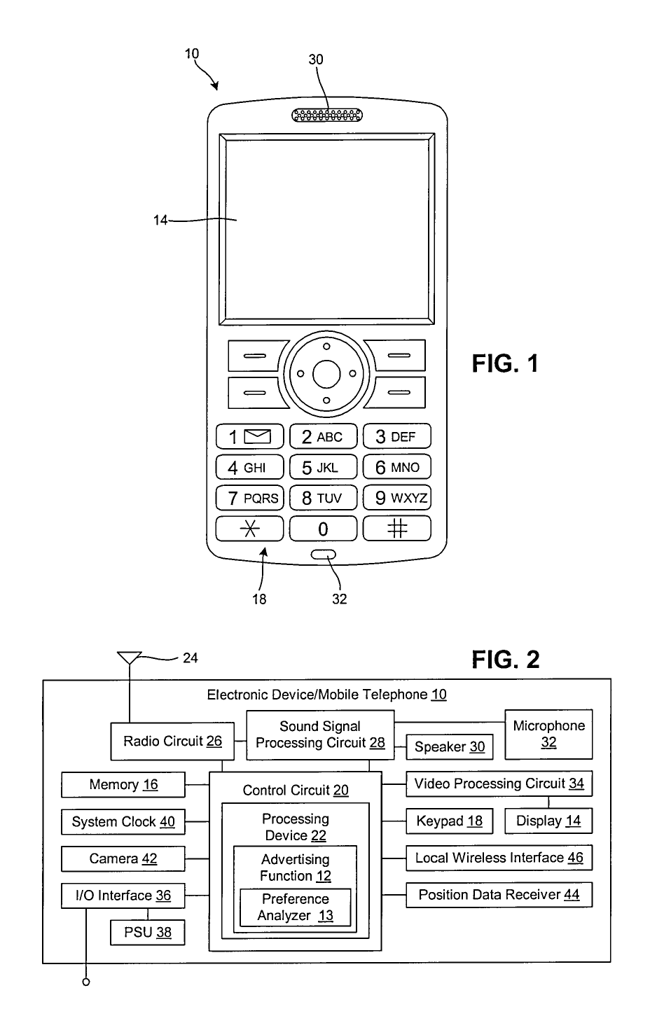

Referring initially to FIGS. 1 and 2, an electronic device 10 is shown. The electronic device 10 includes an advertising function 12 that is configured to download and display advertisements to a user. The advertising function 12 can include a preference analyzer 13. Additional details and operation of the advertisement function 12 will be described in greater detail below. The advertising function 12 may be embodied as executable code that is resident in and executed by the electronic device 10. In one embodiment, the advertising function 12 may be a program stored on a computer or machine readable medium. The advertising function 12 may be a stand-alone software application or form a part of a software application that carries out additional tasks related to the electronic device 10. It will be appreciated that the advertising function 12 may be embodied as executable code that may be resident in and executed by the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

In addition, the processing device 22 may execute code that implements the advertising function 12. It will be apparent to a person having ordinary skill in the art of computer programming, and specifically in application programming for mobile telephones or other electronic devices, how to program a mobile telephone 10 to operate and carry out logical functions associated with the advertising function 12. Accordingly, details as to specific programming code have been left out for the sake of brevity. Also, while the advertising function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

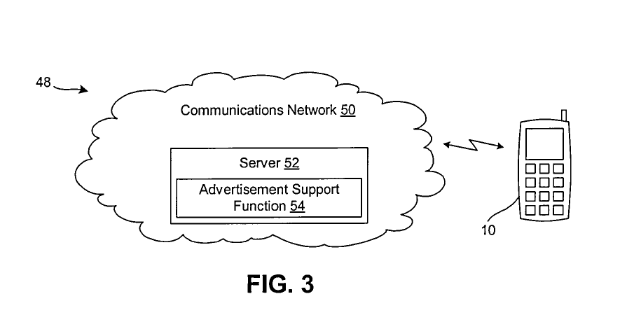

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software. In one embodiment, the server 52 may be configured to store and execute a advertising support function 54 that interacts with the advertising function 12 of the mobile telephone 10. Details of the advertising support function 54 will be described below in greater detail. In one embodiment, the advertising support function 54 may be a program stored on a computer or machine readable medium. The advertising support function 54 may be a stand-alone software application or may form a part of a software application that carries out additional tasks related to the functions of the server 54.

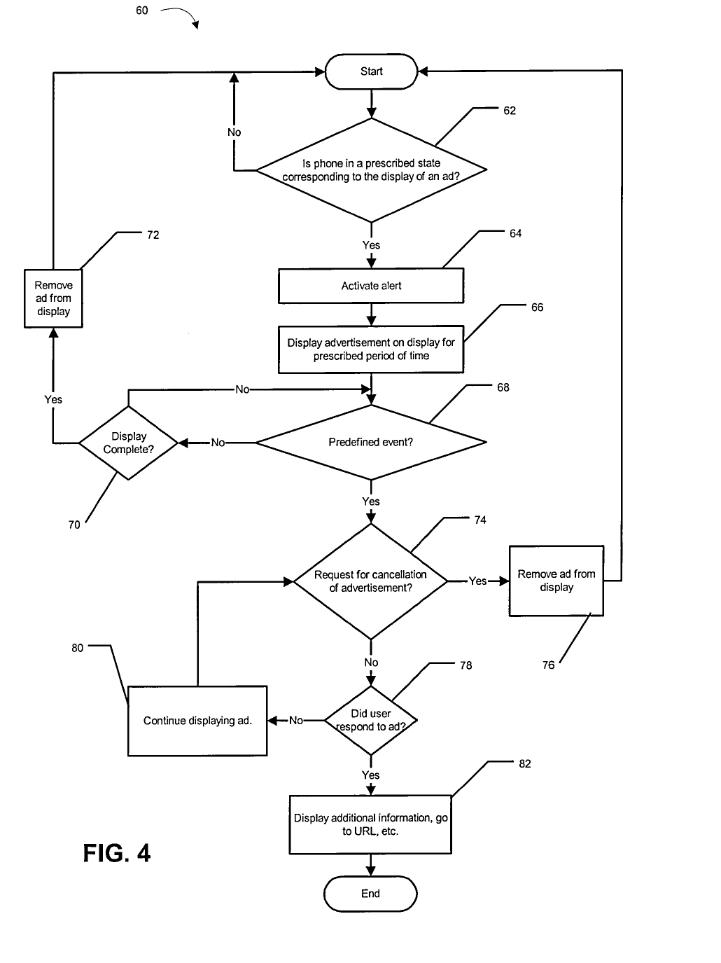

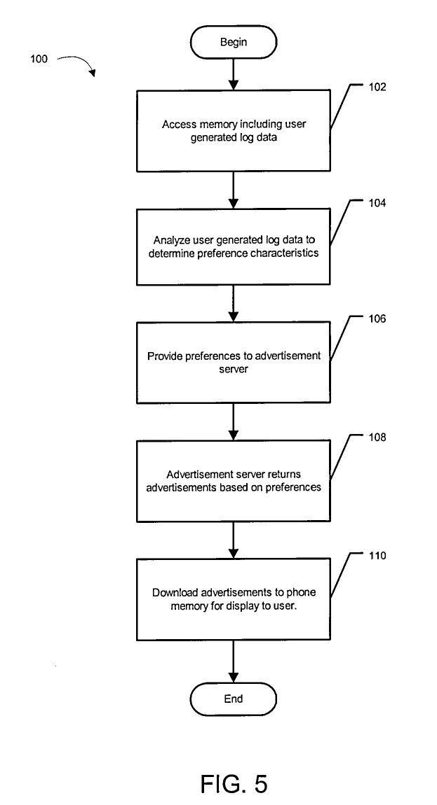

With additional reference to FIGS. 4 and 5, illustrated are logical operations to implement exemplary methods 60 and 100 of providing and displaying advertisements on an electronic device. The exemplary methods 60 and 100 may be carried out by executing an embodiment of the advertising function 12, for example. Thus, the flow charts of FIGS. 4 and 5 may be thought of as depicting steps of a method carried out by the mobile telephone 10. Although FIGS. 4 and 5 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Beginning with block 62 an operation state of the phone 10 corresponding to the display of an advertisement is detected. An operation state can be a period of inactivity of the phone 10, a power on or off sequence, the end of a call, etc. One or more of the operation states can be a prescribed operation state corresponding to the display of an advertisement. In other words, an operation state during which the advertising function is programmed to display an advertisement on the phone 10. For example, if a prescribed operation state is inactivity of the phone 10 (i.e., a certain period of time has transpired during which the user has not interacted with the phone 10), then upon detection of such operation state the method 60 proceeds to block 64 where an alert is activated and then an advertisement is displayed on the display 14 as indicated in block 66.

Activation of the alert in block 64 can be used to draw the attention of the user to the phone 10. The alert can be an audiovisual alert, such as a beep, ringtone and/or flashing light. The alert can include pulsing a backlight of the display 14, for example, or activating a vibration feature of the phone 10. The alert can be triggered at any time relative to the actual display of the advertisement. For example, the alert can occur prior to the display of the advertisement, simultaneously with the display of the advertisement, or periodically throughout the duration of the display of the advertisement so as to continually alert the user to the display of an advertisement.

As mentioned, at block 66 the advertisement is displayed. The advertisement can be audio (like a radio advertisement), video, or a combination of both. The advertisement can be basic text, for example. One type of advertisement that can be used in accordance with the invention is a so-called “special offer” or “one-time offer” advertisement. Such advertisements may be for a product or service offered at a special price for a limited time such as, for example, the period of time the advertisement is displayed on the phone 10. In such case, a user would be required to respond to the advertisement during the display thereof in order to take advantage of the special offer. The use of such types of advertisements may encourage and/or motivate a user to review advertisements so as to not miss any special offers

At block 68, it is determined whether a predefined event has occurred. A predefined event can be, for example, user interaction with the phone such as pressing a button to cancel the advertisement or to request more information about the advertisement. In addition, moving or picking up the phone 10 can be a predefined event. Such movement could be sensed, for example, by one or more onboard accelerometers. Other predefined events can include an incoming call, voicemail, text message, alarm, etc.

If no predefined event occurs, the advertisement is displayed until it is determined at block 70 that the display of the advertisement is complete, at which time the advertisement is removed from the phone's display 12 at block 72 and the method moves back to block 62. In this regard, each advertisement can have associated therewith a display duration. Thus, a given advertisement may be displayed for a period of 1 minute, for example, unless a predefined event occurs, as described. Other advertisements, for example animated advertisements and/or advertisements that include audio and/or video, may be displayed for a period of time corresponding to the standard play length of the advertisement. By having a display duration associated with the advertisement, the user may not always encounter an advertisement when interacting with an inactive phone, for example. This can be advantageous for avoiding the user developing a negative attitude towards the advertisements as the display of advertisements may appear somewhat random, and will not always be present on the display 14 of the phone 10.

Moving back to block 68, if a predefined event occurs, for example a user pressing a button on the phone 10 during the display of the advertisement, then in block 74 it is determined whether the predefined event is a request for cancellation of the advertisement. A request for cancellation can be the user canceling the advertisement by pressing one or more designated cancel buttons on the phone 10. A request for cancellation also can be automatically generated in response to certain predefined events. For example, if an incoming call is received, the advertising function can automatically generate a request for cancellation of the advertisement to allow the user to answer the call.

At block 74, if the predetermined event is a request for cancellation of the advertisement, then the advertisement is removed from the display at block 76. The method moves back to block 62 and the user can access the standard phone user interface to place and answer calls, send text messages, etc. If the user request cancellation of the advertisement, preferably only a single button press would be needed so as to not be overly burdensome to the user. In addition, as mentioned if an incoming call or other event is received by the phone 10 during the display of an advertisement, the request for cancellation can be automatically generated by the advertisement function 12. As will be appreciated, the advertisement then may be redisplayed at the termination of the call. In this regard, such an operation state (e.g., termination of a call) would be detected by the advertisement function 12 in method step 62.

If the advertisement has not been canceled, then at block 78 it is determined whether the user has responded to the advertisement, for example by requesting more information or otherwise interacting with the advertisement. In this regard, a certain button or buttons can be dedicated “respond” buttons. For example, a “select” key can be the dedicated response button for all advertisement such that a user will learn that he only need depress such button during the display of the advertisement to request more information or otherwise interact with the advertisement.

If the user has responded to the advertisement, then at block 82 additional information typically will be displayed. Responding to the advertisement can include requesting additional information about the product or service in the advertisement. In this regard, an advertisement can include one or more links or URLs that, when selected by the user, provide additional information. The links can be to additional text, graphics, videos, an order form for placing an order, etc.

If the user has interacted with the phone but has not responded to the advertisement, at block 80 the advertisement is displayed until either the advertisement is canceled at block 74, or the user responds to the advertisement at block 78. Thus, in this embodiment once the user interacts with the phone 10 during display of the advertisement, the advertisement will remain on the display 14 until either it is canceled or the user responds to the advertisement. It will be appreciated that the advertisement function 12 could also be configured to remove the advertisement from the display 14 after a period of time, regardless of whether the user has responded to the advertisement. In this regard, a maximum display period can be assigned to regulate the maximum amount of time that a given advertisement may be displayed.

A user's response, or lack thereof, to an advertisement can be logged, and such information can be used by advertisers to determine the effectiveness of a particular advertisement. For example, information such as whether the user interacts with an advertisement, cancels an advertisement, or the advertisement is removed from the display without cancellation by the user (e.g., advertisement is displayed for maximum period of time) can be returned to an advertiser. Such information can be valuable to advertisers for assessing the effectiveness of advertisements and developing future advertisements.

It will be appreciated that the advertising function 12 can be configured to operate in essentially the same fashion as a key guard function. For example, when an advertisement is displayed, only a certain key or combination of keys can be depressed to cancel and clear the advertisement from the display in order to access the normal phone user interface. Accordingly, the advertising function 12 can act as a key guard by preventing unwanted calls from being placed, etc. Alternatively, the advertising function 12 can be configured to work in conjunction with a key guard function of the phone 10. In such a configuration, an advertisement would be displayed when the key guard is activated. Upon deactivation of the key guard, the advertisement can be automatically canceled and cleared from the display 14. To respond to the advertisement, a separate key or key combination (other than the key combination required to deactivate the key guard) can be assigned.

It also will be appreciated that the advertisements can be automatically downloaded into the phone's memory 16 by the advertising function 12. For example, during periods of low activity (e.g., overnight), the advertising function 12 can be configured to connect to an advertisement server via the communications network to download new advertisements to the phone's memory. The advertisements can then be stored in the memory 16 until they are displayed. New advertisements can be downloaded periodically so as to continually provide fresh advertisements to the user. In this regard, the advertisement support function 54 residing on the advertisement server can control which advertisements are downloaded by the phone. For example, the advertisement support function 54 can log which advertisements have already been displayed on the phone 10 to ensure that only new advertisements are downloaded by the phone 10 for display in the future.

Advertisements may also be streamed directly to the electronic device and displayed on the display. In such case, the advertisement function 12 would be configured to connect to an advertisement server to stream the advertisement to the electronic device.

Further, the advertisement function 12 can utilize information stored in the memory 16 of the phone 10 for targeting advertisements to the user. For example, typical phones have one or more logs stored in memory containing information such as text messages, email messages, mp3s played, location information, etc. The preference analyzer function 13 of the advertisement function 12 can be used for determining user preferences from such data.

Turning to FIG. 5, and in accordance with an aspect of the invention, an exemplary method of analyzing preferences is illustrated. The method 100 begins with block 102 wherein the preference analyzer 13 of the advertising function 12 accesses memory 16. In block 104, the preference analyzer 13 analyzes the log data stored in memory 16 to determine user preferences. The preference analyzer 13, for example, can analyze the content of messages for keywords. For example, if a text message includes the term “baseball”, the analyzer can recognize the term and determine assign “baseball” as a user preference.

In block 106, the preference analyzer 13 provides the one or more determined user preferences to an advertisement server, via the internet or directly (e.g., via RF transceiver 78, Bluetooth, or the like). The advertisement server can be server 52 or another server. The advertisement server then returns advertisements based on the determined preferences if such advertisements exist in block 108. By way of example, the analyzer may determine the following preferences in block 104: baseball, rolling stones, rock and roll, Ferrari. Such preferences could be determined from the content of text messages and/or emails stored in the phone's logs. In block 106, the advertisement server returns advertisements related to these preferences, for example an advertisement for a local professional baseball team or an advertisement for a concert. If no advertisements are available that relate to the determined preferences, the server can return one or more random advertisements. The advertisements are then downloaded to the memory 16 of the phone 10 for display.

The phone 10 can include a user defined preference log containing preferences set by the user. Accordingly, a user can control at least some of the types of advertisements displayed on the phone 10. For example, the advertising function can include a user preference application for guiding the user to define preferences. Such an application can be accessed through one or more menus of the phone 10 and the user's preferences stored in the preference log for use by the preference analyzer 13 in the above-described manner.

It will be appreciated that location information (geographical position information) can be used to target advertisements to the user in a given geographical location. Accordingly, advertisements from local (to the user) businesses can be provided to the user when the user enters a predefined range of the business, for example. The current location of the mobile telephone 10 may be determined using any appropriate positioning technology.

For instance, the location determination mechanism may include accessing an identity of a communications access point (e.g., communications tower) servicing the mobile telephone 10. In one embodiment, the communications tower may be part of a cellular network (e.g., a “cell” tower) that has an associated identifier (e.g., “cell ID”) and the identifier is communicated to the mobile telephone 10 or the server 52 as an identifier or position. Each identifier or cell ID in a particular servicing network may be assumed to be unique and, therefore, may be used to indicate relative proximity to a certain location. The cell ID and any related radio parameters may be used to generate a coordinate value through a radio network service. For example, under global system mobile communications (GSM) and universal mobile telecommunications system (UMTS) protocols, the position could be estimated through a mobile originated location request (MO-LR) to the network so that the mobile telephone 10 position could be estimated using the network's knowledge of tower locations and antenna directions.

Location information may be determined by receipt of location data from a dedicated system, such as a global positioning satellite (GPS), Galileo satellite system or the like. Such data may be received via the position data receiver 44, if present as part of the mobile telephone 10. For instance, GPS coordinates may be expressed using a standard reference system (e.g., the world geodetic system or WGS). Also, assisted-GPS (or A-GPS) may be used to determine the location of the mobile telephone 10. A-GPS uses an assistance server, which may be implemented with the server 52. The assistance server processes location related data and accesses a reference network to speed location determination and transfer processing tasks from the mobile telephone 10 to the server 52. For instance, the assistance server may perform tasks to make range measurements and calculate position solutions that would otherwise be carried out by the position data receiver 44 or elsewhere in the mobile telephone 10.

It will be appreciated that the term “audiovisual content” broadly refers to any type of audio-based and/or video-based subject matter and may be take the form of a stored file or streaming data. Stored files may include, for example, an image file (e.g., a photograph), a music file, a ring tone, a video file, and so forth and may be stored locally by a memory of the electronic device or remotely, such as by a server. Streaming data may relate to a service that delivers audio and/or video for consumption by the electronic device and may include, for example mobile radio channels or mobile television channels. As used herein, the term “audiovisual content” expressly excludes call related operation of the electronic device 10 (e.g., generation of calling tones and/or the display of numbers or contact data on a display in connection with making or receiving a call) and expressly excludes electronic device operational functions unrelated to audio and/or video playback functions, such as menu navigation, manipulating electronic device settings, contact list management, message functions, photography functions, Internet usage functions, and so forth.

It will further be appreciated that aspects of the invention can be used in connection with a screensaver for an electronic device. For example, display of an advertisement as described above can be part of a screensaver routine that displays various images during periods when the electronic device is inactive.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of displaying advertisements on an electronic device comprising:
providing an advertisement to the electronic device;
detecting at least one prescribed condition of the electronic device corresponding to display of the advertisement; and
displaying the advertisement on a display of the electronic device when the prescribed condition is detected;
wherein the advertisement is displayed for a prescribed period of time during which the advertisement can be canceled based on the occurrence of a predefined event.

2. A method as set forth in claim 1, wherein the predefined event includes cancellation of the advertisement by a user.

3. A method as set forth in claim 1, wherein the providing an advertisement to the electronic device includes streaming the advertisement to the device.

4. A method as set forth in claim 1, wherein the providing an advertisement to the electronic device includes downloading the advertisement to a memory of the device.

5. A method as set forth in claim 1, wherein the prescribed condition is a period of inactivity of the electronic device.

6. A method as set forth in claim 1, wherein the prescribed condition is a geographical location of the electronic device.

7. A method as set forth in claim 1, wherein the advertisement is at least one of an image, a video, a sound, or text.

8. A method as set forth in claim 1, wherein the advertisement includes a link selectively activatable by a user for accessing additional information.

9. A method as set forth in claim 1, further comprising activating at least one of an audio, a visual, or a vibrating indicator for alerting the user to the display of the advertisement.

10. A method as set forth in claim 1, further comprising targeting advertisements based upon information available from the electronic device, wherein the targeting includes:
accessing a memory of the electronic device, the memory including data related to the operation of the electronic device;
analyzing at least the data related to operation of the electronic device to determine at least one user preference;
generating a list of user preferences; and
using the list of preferences to determine advertisements to be provided to the electronic device for display to the user.

11. A method as set forth in claim 10, further comprising searching an advertisement server for advertisements related to the determined preferences.

12. A method as set forth in claim 10, wherein the accessing the memory includes accessing at least one of call log data, message log data, video/picture log data, MP3 log data, location log data, environmental log data, calendar log data, user defined preference log data, and voice memo log data.

13. A method as set forth in claim 1, wherein the advertisement is a limited time advertisement that expires after a prescribed time.

14. A method as set forth in claim 1, wherein the advertisement is automatically canceled upon occurrence of a predefined event.

15. A method as set forth in claim 1, wherein the displaying the advertisement includes displaying the advertisement in connection with a screensaver.

16. A method of targeting advertisements based upon information available from an electronic device, wherein the targeting includes:
accessing a memory of the electronic device, the memory including data related to the operation of the electronic device;
analyzing at least the data related to operation of the electronic device to determine at least one user preference;
generating a list of user preferences; and
using the list of preferences to determine advertisements to be provided to the electronic device for display to the user.

17. A method as set forth in claim 16, further comprising searching an advertisement server for advertisements related to the determined preferences.

18. A method as set forth in claim 16, wherein the accessing the memory includes accessing at least one of call log data, message log data, video/picture log data, MP3 log data, location log data, environmental log data, calendar log data, user defined preference log data, and voice memo log data.

19. An electronic device comprising:
call circuitry to establish a communication link to a communication network; and
advertising circuitry;
wherein the advertising circuitry is operative to retrieve an advertisement, detect at least one prescribed condition of the electronic device corresponding to display of the advertisement, and display the advertisement on a display of the electronic device when the prescribed condition is detected; and
wherein the advertisement is displayed for a prescribed period of time during which the advertisement can be canceled based on the occurrence of a predefined event.

20. The electronic device of claim 19, wherein the electronic device is a mobile telephone.
